(19) United States
(12) Patent Application Publication
(10) Pub. No.: US 2014/0196700 A1
(43) Pub. Date: Jul. 17, 2014

(54) HEAT EXCHANGER

(71) Applicants: Wolfgang Bucher, Stuttgart (DE); Steffen Brunner, Weissach im Tal (DE); Peter Geskes, Ostfildern (DE); Achim Herber, Bietigheim-Bissingen (DE); Christian Faber, Stuttgart (DE); Philipp Hetz, São Paulo - Pinheiros (BR); Simon Hund, Stuttgart (DE); Timm Röschmann, Nufringen (DE); Albrecht Siegel, Ludwigsburg (DE); Wolfgang Wehrstedt, Mühlacker (DE)

(72) Inventors: Wolfgang Bucher, Stuttgart (DE); Steffen Brunner, Weissach im Tal (DE); Peter Geskes, Ostfildern (DE); Achim Herber, Bietigheim-Bissingen (DE); Christian Faber, Stuttgart (DE); Philipp Hetz, São Paulo - Pinheiros (BR); Simon Hund, Stuttgart (DE); Timm Röschmann, Nufringen (DE); Albrecht Siegel, Ludwigsburg (DE); Wolfgang Wehrstedt, Mühlacker (DE)

(73) Assignee: BEHR GMBH & CO. KG, Stuttgart (DE)

(21) Appl. No.: 14/122,747

(22) PCT Filed: May 30, 2012
(86) PCT No.: PCT/EP2012/060118

§ 371 Date: Mar. 21, 2014

(30) Foreign Application Priority Data
May 31, 2011 (DE) 10 2011 076 800.9

(51) Int. Cl. F02M 25/07; F28F 9/02

(52) U.S. Cl. CPC F02M 25/0737; F28F 9/02
USPC 123/568.12; 165/158

(57) ABSTRACT

Disclosed herein is a heat exchanger with a housing casing, a first base and a second base with openings, pipes as a first flow channel for conducting a first fluid, the ends thereof being arranged in or on the openings of the first and second bases, the pipes and the first and/or the second base are arranged within the housing so that a second flow channel for conducting a second fluid is designed between the housing and the pipes, a first inlet opening for the first fluid, a first outlet opening for the first fluid, a second inlet opening for the second fluid, a second outlet opening for the second fluid, a first diffusor for directing the first fluid into the pipes, a second diffuser for directing the first fluid out of the pipes, which heat exchanger should be simple and cost-effective to produce and ensure reliable operation.

The invention relates to a heat exchanger as per the preamble of claim 1 and to an arrangement for the recirculation and cooling of exhaust gas of an internal combustion engine as per the preamble of claim 10.

Heat exchangers, in particular exhaust-gas heat exchangers, are used for a variety of technical applications for the transfer of heat from a first fluid to a second fluid. Here, both the first fluid and the second fluid flow through the heat exchanger, and in the process the heat is transferred from the first to the second fluid or vice versa. In an exhaust-gas heat exchanger, exhaust gas as first fluid is conducted through a multiplicity of tubes in the form of flat tubes. Here, cooling liquid as second fluid is conducted around the flat tubes. Heat is thus transferred from the hot exhaust gas to the cooling liquid, and the exhaust gas is thus cooled.

Exhaust-gas heat exchangers generally have a housing, two plates with openings, and a multiplicity of tubes, the ends of which are arranged in the plates. The tubes with the two plates are in this case arranged within the housing, such that, in the heat exchanger, a first flow duct for the exhaust gas is formed in the tubes, and a second flow duct for the cooling liquid is formed between the tubes. The components of the heat exchanger are in this case generally composed of metal, in particular aluminum or high-grade steel, and are preferably cohesively connected to one another by means of brazing.

DE 10 2005 005 190 A1 discloses an exhaust-gas cooler arrangement having a housing, in which a heat transfer region is arranged, and having a final control element for regulating the exhaust-gas flow through the heat transfer region, and/or having a bypass duct. The housing is formed in one piece as viewed in the longitudinal direction of the exhaust-gas cooler arrangement, wherein the final control element is arranged in the housing.

EP 1 922 520 B1 presents an exhaust-gas heat exchanger having a tube bundle, which is composed of exhaust-gas tubes, and having a bypass duct. A liquid coolant can flow through a housing, wherein the tube bundle and the bypass duct issue in each case into a common exhaust-gas inlet region in which there is arranged an exhaust-gas valve for controlling the exhaust-gas flow through the tube bundle or through the bypass duct, wherein the bypass duct is formed by a high-grade steel tube with a casing composed of high-temperature-resistant plastic and is arranged in the housing through which coolant can flow.

DE 11 2007 001 061 T5 presents a heat exchanger which has the following: a first fluid passage which extends between a first inlet connector and a first outlet connector, a second fluid passage which extends between a second inlet connector and a second outlet connector, wherein the first and the second fluid passage are sealed off with respect to one another, at least one heat transfer surface through which the first and second fluid passages communicate for a transfer of heat, and at least one electrode which is arranged in the second fluid passage, wherein the at least one electrode is connected to a voltage source which, during usage of the heat exchanger, applies a voltage to the at least one electrode, and wherein the voltage is of a sufficient magnitude to trigger the generation of a non-thermal plasma in the second fluid passage by the at least one electrode.

It is therefore the object of the present invention to provide a heat exchanger and an arrangement for the recirculation and cooling of exhaust gas of an internal combustion engine, said heat exchanger and arrangement respectively being simple and inexpensive to produce and ensuring reliable operation of the heat exchanger, and in particular exhibiting adequate sealing.

Said object is achieved by means of a heat exchanger, in particular exhaust-gas or charge-air heat exchanger, comprising a housing with a housing jacket, a first plate and a second plate with openings, tubes as a first flow duct for conducting a first fluid, in particular exhaust gas, the ends of which tubes are arranged in or on the openings of the first and second plates, the tubes and the first and/or second plates are arranged within the housing such that a second flow duct for conducting a second fluid, in particular a cooling liquid, is formed between the housing and the tubes, a first inlet opening for the first fluid, a first outlet opening for the first fluid, a second inlet opening for the second fluid, a second outlet opening for the second fluid, a first diffuser for the introduction of the first fluid into the tubes, a second diffuser for the discharge of the first fluid out of the tubes, wherein the first and/or second diffuser is formed integrally with the housing. The first and/or second diffuser is formed integrally with the housing, that is to say the housing jacket, such that as a result, no additional components are required for the first or second diffuser. In this way, the heat exchanger can be produced significantly more easily and at significantly lower cost, because no additional welded or brazed connections are required between the first and/or second diffuser and the housing or the housing jacket.

In particular, the heat exchanger does not have a final control element, for example a flap, for controlling and/or regulating the amount of the first fluid that can be conducted through the first flow duct, and/or the heat exchanger does not have a bypass duct for diverting the first fluid past the tubes.

In a further embodiment, the heat exchanger does not have an electrode, for example for generating a preferably non-thermal plasma. The heat exchanger expediently does not have an electrode connected to a voltage source, such that during usage of the heat exchanger, no voltage can be applied to the electrodes. The heat exchanger is thus not suitable for the treatment of the first fluid, in particular exhaust gas, through the generation, in particular, of a non-thermal plasma.

In an additional embodiment, the diameter of the first and/or second diffuser perpendicular to a longitudinal axis of the tubes corresponds substantially to the diameter of the housing jacket perpendicular to the longitudinal axis at the tubes, preferably in each case in the same direction perpendicular to the longitudinal axis of the tubes. This substantially means that the diameter of the first and/or second diffuser differs from the diameter of the housing jacket by only a difference of less than 30%, 20%, 10%, 5% or 2%. Here, the diameter of the housing jacket is detected or measured preferably in the region of the first and/or second plate.

It is preferable for the first diffuser to be closed by a first cover and/or for the second diffuser to be closed by a second cover. The first and/or second diffuser is formed analogously to the housing jacket in cross section, since the first and/or second diffuser is formed integrally with the housing jacket. The inlet and outlet opening for the first fluid is formed on the first and/or second diffuser, such that a first and/or second cover is required in order to realize an inlet and/or outlet opening for the first fluid with a significantly smaller flow cross-sectional area than the flow cross-sectional area on the first and/or second diffuser.

In a further variant, the first inlet opening is formed on the first cover or on the first diffuser, and a first inlet connector is preferably formed on the first cover with the first inlet opening, and/or the first outlet opening is formed on the second cover or on the second diffuser, and a first outlet connector is preferably formed on the second cover with the first outlet opening. By means of the first inlet connector or the first outlet connector, the exhaust gas can be conducted into or out of the heat exchanger in a particularly simple manner, and a line can be connected to the first inlet or outlet connector in a particularly simple manner.

It is expedient if the second inlet opening and/or the second outlet opening is formed on the housing and a preferably milled or deep-drawn connector is arranged on the second inlet and/or outlet opening, said connector preferably being connected under preload to the housing at the second inlet and/or outlet opening, the connector preferably being connected to the housing in a fluid-tight manner by way of a seal, in particular O-ring seal. The preload between the connector and the housing is preferably substantially perpendicular or parallel to the flow direction of the second fluid flowing through the inlet and/or outlet opening. Here, during the production process, the connector is inserted into an opening, that is to say the inlet or outlet opening in the housing jacket, and subsequently, by means of a rolling tool, the preload between the connector and the housing is produced, and preferably a collar is produced in order to realize a larger contact surface between the connector and the housing.

In a further embodiment, the second inlet opening and/or the second outlet opening is formed on the housing and an elastic connector, in particular rubber connector, is arranged on the second inlet and/or or outlet opening. During the production process, a rim hole is produced on the inlet and/or outlet opening, preferably by means of deep drawing, and the elastic connector is subsequently inserted into the inlet and/or outlet opening for the second fluid, in particular cooling liquid. A water collecting rail is arranged between the housing or the housing jacket and the elastic connector such that, in this way, the elastic connector rests on the inlet and/or outlet opening for the second fluid so as to be under preload or pressure between the water collecting rail and the housing jacket, and a fluid-tight connection is ensured by means of the elastic connector.

In particular, the components of the heat exchanger are brazed and/or welded to one another and/or the components of the heat exchanger are composed at least partially, in particular entirely, of metal, preferably aluminum or high-grade steel. The components of the heat exchanger are for example the housing, for example the housing jacket, the first and/or second plate, the tubes, the first and/or second cover, the first and/or second inlet connector, and/or the connector.

In an additional variant, the first inlet opening for the first fluid, in particular exhaust gas, is formed on the first diffuser, and/or the first outlet opening for the first fluid, in particular exhaust gas, is formed on the second diffuser.

It is expedient for diverting baffles to be arranged in the first flow duct within the first and/or second diffuser.

Arrangement according to the invention for the recirculation and cooling of exhaust gas of an internal combustion engine, in particular of a diesel engine, comprising an exhaust line, preferably with an exhaust-gas turbine, a charge-air line with a charge-air compressor that can preferably be driven by the exhaust-gas turbine, an exhaust-gas recirculation line for conducting exhaust gas from the exhaust line to the charge-air line, an exhaust-gas heat exchanger for cooling exhaust gas in the exhaust-gas recirculation line and/or a charge-air heat exchanger for cooling charge air in the charge-air line downstream of the charge-air compressor as viewed in the flow direction of the air, preferably an exhaust-gas control element for controlling and/or regulating the amount of exhaust gas that can be conducted through the exhaust-gas recirculation line per unit of time, and/or preferably a charge-air control element for controlling and/or regulating the amount of charge air that can be conducted through the charge-air line per unit of time, wherein the exhaust-gas heat exchanger and/or the charge-air heat exchanger is designed as a heat exchanger described in this property right application.

In a further embodiment, turbulence inserts are arranged within the tubes. The turbulence inserts, preferably guide baffles, serve to generate a turbulent flow for the flow of the first fluid through the tubes in order to increase the heat transfer from the first fluid to the second fluid or vice versa.

In a further embodiment, fins or turbulence inserts are arranged between the tubes, that is to say within the second flow duct, in particular for the cooling liquid. In this way, it is sought to realize as turbulent a flow as possible as the second fluid, in particular the cooling liquid, flows around the tubes.

Exemplary embodiments of the invention will be described in more detail below with reference to the appended drawings, in which:

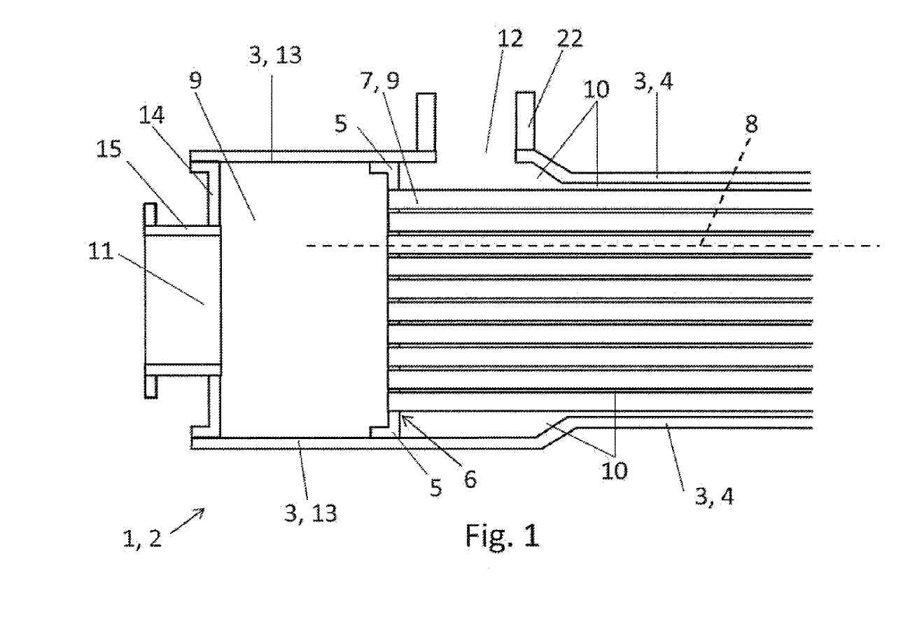

FIG. 1 shows a partial longitudinal section of a heat exchanger in a first exemplary embodiment,

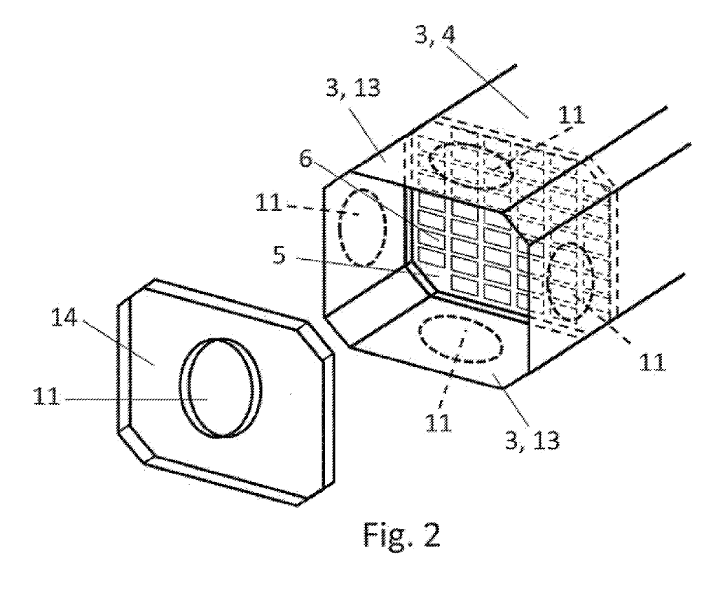

FIG. 2 shows a partially exploded illustration of the heat exchanger as per FIG. 1,

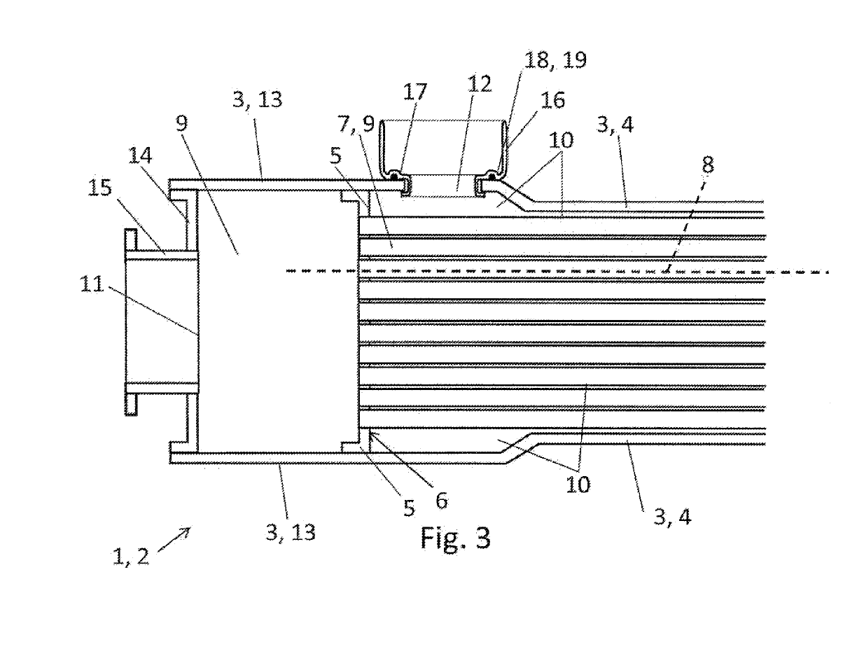

FIG. 3 shows a partial longitudinal section of the heat exchanger in a second exemplary embodiment, and

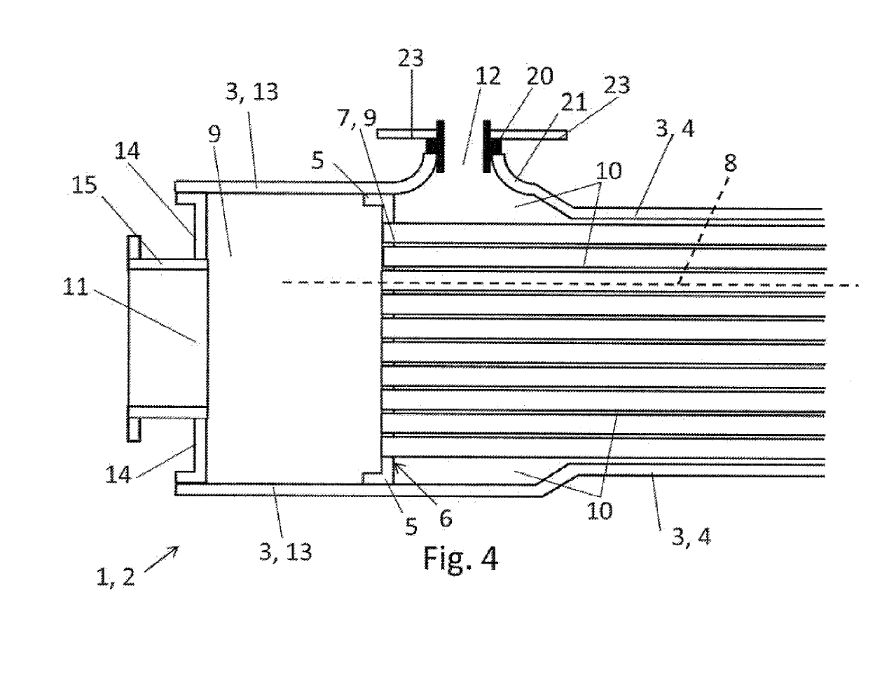

FIG. 4 shows a partial longitudinal section of the heat exchanger in a third exemplary embodiment.

A heat exchanger 1 in the form of an exhaust-gas heat exchanger 2 serves for the cooling of exhaust gas, as a first fluid, by means of cooling liquid. Here, the exhaust-gas heat exchanger 2 has a first flow duct 9 for conducting a first fluid, specifically exhaust gas. A second flow duct 10 for conducting a second fluid, specifically cooling liquid, serves to transfer heat from the exhaust gas to the cooling liquid and thereby cool the exhaust gas (FIGS. 1, 3 and 4). The exhaust-gas heat exchanger 2 is in this case used in an arrangement (not illustrated) for the recirculation and cooling of exhaust gas of an internal combustion engine in order to cool the exhaust gas from the internal combustion engine by means of cooling liquid of the internal combustion engine, and subsequently, after the cooling process in the exhaust-gas heat exchanger 2, supply said exhaust gas back to a charge-air line (not illustrated) in order for it to undergo further combustion in a combustion chamber of the internal combustion engine.

FIGS. 1 and 2 show a first exemplary embodiment of the heat exchanger 1. The exhaust-gas heat exchanger 2 has a multiplicity of tubes 7 which are arranged within a housing jacket 4 of a housing 3 of the exhaust-gas heat exchanger 2. The tubes 7 serve for conducting exhaust gas, and an intermediate space provided within the housing jacket 4 and outside the tubes 7 serves for conducting cooling liquid as second fluid.

In the longitudinal section, illustrated in FIG. 1, of the heat exchanger 1 in the first exemplary embodiment, substantially only the first half of the heat exchanger 1, with a first inlet opening 11 for exhaust gas as first fluid and with a second inlet opening 12 for the second fluid, specifically cooling liquid, is illustrated. The other half (not illustrated) of the heat exchanger 1 is in this case configured analogously to the half illustrated in FIG. 1, and is substantially axially symmetrical with respect thereto. It is merely the case that the second outlet opening (not illustrated) for the cooling liquid is not, like the second inlet opening 12 for the cooling liquid, formed on the top; rather, the second outlet opening for the cooling liquid is formed on the bottom of the housing jacket 4 (not illustrated) in the second half, which is not illustrated, of the heat exchanger. In the two end regions of the housing jacket 4, a first plate 5 and a second plate is connected in each case in a fluid-tight manner to the housing jacket 4, for example by means of brazing or welding. The first plate 5 and the second plate (not illustrated) have in this case a multiplicity of openings 6, and in the openings 6, the tubes are connected in a fluid-tight manner to the first and second plate 5. In this way, the second flow duct 10 for conducting cooling liquid is formed within the housing jacket 4 and outside the tubes 7 and also between the first plate 5 and the second plate. The housing jacket 4 is elongated beyond the first plate 5 and the second plate in the direction of a longitudinal axis 8 of the tubes 7, such that said elongation of the housing jacket 4 also forms a first diffuser 13 and the second diffuser. The first diffuser 13 is closed by a first cover 14 with the first inlet opening 11, and analogously, the second diffuser (not illustrated) is closed by a second cover with a first outlet opening for the exhaust gas. A first inlet connector 15 is fastened in the first inlet opening 11 for the exhaust gas on the first cover 14. Analogously, a first outlet connector is fastened (not illustrated) to the second cover on the first outlet opening for the exhaust gas. In this way, the first flow duct 9 for the exhaust gas is formed between the first diffuser 13 and the first cover 14 and also the first plate 5, and the exhaust gas is introduced into said chamber through the inlet opening 11. The exhaust gas can subsequently flow through said chamber into the multiplicity of tubes 7, and after the exhaust gas is conducted through the tubes 7, the exhaust gas flows into the chamber enclosed by the second diffuser and the second cover and also the second plate, said exhaust gas subsequently flowing out of the first outlet opening on the second cover. A coolant connector 22 is arranged, for example in particular brazed, to the second inlet opening 12 for the cooling liquid, and a further coolant connector 22 is analogously arranged on the second outlet opening (not illustrated) for the cooling liquid.

By contrast to the formation of the first inlet opening 11 for the exhaust gas on the first cover 14, it is possible for the first cover 14 to have no inlet opening 11, and in a departure from this, the inlet opening 11 may be formed for example on four different regions of the first diffuser 13. Said inlet openings 11 are illustrated by dashed lines in FIG. 2. Said formation of the inlet openings 11 on the first diffuser 13, or on the elongation of the housing jacket 4 which forms the first diffuser 13, also applies analogously to the formation of the first outlet opening on the second diffuser (not illustrated).

FIG. 3 illustrates a second exemplary embodiment of the heat exchanger 1. Substantially only the differences with respect to the first exemplary embodiment as per FIGS. 1 and 2 will be described below. A connector 16 composed of metal, for example aluminum or high-grade steel, is arranged on the second inlet opening 12 for the cooling liquid. For the fastening of the connector 16 to the inlet opening 12, the connector 16 which is produced by means of milling or deep drawing is inserted into said second inlet opening 12, and subsequently, a collar 17 is produced both on the outer side of the housing jacket 4 and also on the inner side of the housing jacket 4 by means of a rolling tool. Furthermore, owing to the connection between the connector 16 and the housing jacket 4 in the region of the second inlet opening 12 by means of the rolling tool, a preload is produced between the connector 16 and the housing jacket 4. Furthermore, an annular groove is formed on the connector 16, and a seal 18 in the form of a O-ring seal 19 is arranged within the annular groove. Owing to the preload between the connector 16 and the housing jacket 4, the O-ring seal 19 lies on the outer side of the housing jacket 4 under compressive preload and thereby ensures permanent and fluid-tight sealing of the connector 16 with respect to the housing jacket 4. Said design of the connector 16 for the inlet opening 12 also applies analogously to a connector 16 on the second outlet opening for the cooling liquid (not illustrated).

FIG. 4 illustrates a third exemplary embodiment of the heat exchanger 1. Substantially only the differences in relation to the first exemplary embodiment as per FIGS. 1 and 2 will be described below. A rim hole 21, produced for example by means of deep drawing, is formed on the housing jacket 4 in the region of the second inlet opening 12 for cooling liquid. An elastic connector 20 is inserted into the second inlet opening 12. A water collecting rail 23 of a motor vehicle lies on the elastic connector 20. Here, the elastic connector 20 is elastically preloaded between the water collecting rail 23 with an opening and the housing jacket 4 in the region of the rim hole 21, such that in this way, a fluid-tight connection is formed between the water collecting rail 23 and the housing jacket 4 by means of the elastic connector 20. The rim hole 21 may also be calibrated by means of a rolling method after the deep-drawing process, that is to say a higher level of production accuracy of the rim hole 21 can be attained. It is preferable here for the second outlet opening (not illustrated) for the cooling liquid to be formed analogously to the second inlet opening 12, with the elastic connector 20, illustrated in FIG. 4.

Viewed as a whole, the heat exchanger 1 according to the invention and the arrangement according to the invention for the recirculation and cooling of exhaust gas of an internal combustion engine are associated with significant advantages. The heat exchanger 1 without a final control element for the exhaust gas and without an electrode has a housing jacket 4 as a housing 3, which housing jacket forms both the first diffuser 13 and also the second diffuser because the housing jacket 4 is formed so as to be elongated beyond the first plate 5 and the second plate. In this way, costs can be saved during the production of the heat exchanger because no additional components are required for the first diffuser 13 and the second diffuser. Furthermore, there is also no need for a connection, in particular a brazed or welded connection, between the first diffuser 13 and the second diffuser and also the housing jacket 4.

### LIST OF REFERENCE NUMERALS

1 Heat exchanger

2 Exhaust-gas heat exchanger

3 Housing

4 Housing jacket

5 First plate

6 Openings in plate

7 Tubes

8 Longitudinal axis of the tubes

9 First flow duct for exhaust gas

10 Second flow duct for cooling liquid

11 First inlet opening for exhaust gas

12 Second inlet opening for cooling liquid

13 First diffuser

14 First cover

15 First inlet connector

16 Connector

17 Collar

18 Seal

19 O-ring seal

20 Elastic connector

21 Rim hole

22 Coolant connector

23 Water collecting rail

1. A heat exchanger, in particular exhaust-gas or charge-air heat exchanger, comprising
a housing with a housing jacket,
a first plate and a second plate with openings,
tubes as a first flow duct for conducting a first fluid, in particular exhaust gas, the ends of which tubes are arranged in or on the openings of the first and second plates,
the tubes and the first and/or second plates are arranged within the housing such that a second flow duct for conducting a second fluid, in particular a cooling liquid, is formed between the housing and the tubes,
a first inlet opening for the first fluid,
a first outlet opening for the first fluid,
a second inlet opening for the second fluid,
a second outlet opening for the second fluid,
a first diffuser for the introduction of the first fluid into the tubes,
a second diffuser for the discharge of the first fluid out of the tubes, wherein
the first and/or second diffuser is formed integrally with the housing.

2. The heat exchanger as claimed in claim 1, wherein the heat exchanger does not have a final control element, for example a flap, for controlling and/or regulating the amount of the first fluid that can be conducted through the first flow duct, and/or the heat exchanger does not have a bypass duct for diverting the first fluid past the tubes.

3. The heat exchanger as claimed in claim 1, wherein the heat exchanger does not have an electrode, for example for generating a preferably non-thermal plasma.

4. The heat exchanger as claimed in claim 1, wherein the diameter of the first and/or second diffuser perpendicular to a longitudinal axis of the tubes corresponds substantially to the diameter of the housing jacket perpendicular to the longitudinal axis at the tubes, preferably in each case in the same direction perpendicular to the longitudinal axis of the tubes.

5. The heat exchanger as claimed in claim 1, wherein the first diffuser is closed by a first cover and/or the second diffuser is closed by a second cover.

6. The heat exchanger as claimed in claim 1, wherein the first inlet opening is formed on the first cover or on the first diffuser, and a first inlet connector is preferably formed on the first cover with the first inlet opening, and/or the first outlet opening is formed on the second cover or on the second diffuser, and a first outlet connector is preferably formed on the second cover with the first outlet opening.

7. The heat exchanger as claimed in claim 1, wherein the second inlet opening and/or the second outlet opening is formed on the housing and a preferably milled or deep-drawn connector is arranged on the second inlet and/or outlet opening, said connector preferably being connected under preload to the housing at the second inlet and/or outlet opening, the connector preferably being connected to the housing in a fluid-tight manner by way of a seal, in particular O-ring seal.

8. The heat exchanger as claimed in claim 1, wherein the second inlet opening and/or the second outlet opening is formed on the housing and an elastic connector, in particular rubber connector, is arranged on the second inlet and/or outlet opening.

9. The heat exchanger as claimed in claim 1, wherein the components of the heat exchanger are brazed and/or welded to one another and/or the components of the heat exchanger are composed at least partially, in particular entirely, of metal, preferably aluminum or high-grade steel.

10. An arrangement for the recirculation and cooling of exhaust gas of an internal combustion engine, in particular of a diesel engine, comprising
an exhaust line, preferably with an exhaust-gas turbine,
a charge-air line with a charge-air compressor that can preferably be driven by the exhaust-gas turbine,
an exhaust-gas recirculation line for conducting exhaust gas from the exhaust line to the charge-air line,
an exhaust-gas heat exchanger for cooling exhaust gas in the exhaust-gas recirculation line and/or a charge-air heat exchanger for cooling charge air in the charge-air line downstream of the charge-air compressor as viewed in the flow direction of the air,
preferably an exhaust-gas control element for controlling and/or regulating the amount of exhaust gas that can be conducted through the exhaust-gas recirculation line per unit of time, and/or preferably a charge-air control element for controlling and/or regulating the amount of charge air that can be conducted through the charge-air line per unit of time, wherein
the exhaust-gas heat exchanger and/or the charge-air heat exchanger is designed as a heat exchanger as claimed in claim 1.
